(19) United States
(12) Patent Application Publication
(10) Pub. No.: US 2022/0019641 A1
(43) Pub. Date: Jan. 20, 2022

(54) METHOD AND SYSTEM FOR PROCESSING A SIGNAL TO EXTRACT A USEFUL SIGNAL FROM A DISTURBED SIGNAL

(71) Applicant: LATELEC, LABEGE CEDEX (FR)

(72) Inventor: MAJID SOULEY, TOULOUSE (FR)

(21) Appl. No.: 17/312,348

(22) PCT Filed: Dec. 11, 2019
(86) PCT No.: PCT/EP2019/084743

§ 371 Date: Jun. 9, 2021

(30) Foreign Application Priority Data
Dec. 13, 2018 (FR) 1872882

(51) Int. Cl. G06F 17/13; H02P 23/14; G01R 23/02

(52) U.S. Cl. CPC G06F 17/13; G01R 23/02; H02P 23/14

(57) ABSTRACT

A method for processing a signal to extract a useful signal from a disturbed signal P1 if the disturbed signal P1 is formed as a sum of a sinusoidal component S1 and an additional component X1. The useful signal corresponds to one of these components. Values of the disturbed signal P1 at three successive times t1, t2 and t3 are determined. Values at the three times t1, t2 and t3 are determined of a signal P2 having a sinusoidal component Sa of the same amplitude as the sinusoidal component S1 and in phase quadrature with respect to the sinusoidal component S1. A value of the useful signal at time t3 based on the values of the disturbed signal P1 and the values of the signal P2 at the three successive times t1, t2 and t3 is calculated.

### FIELD OF THE INVENTION

The present invention belongs to the field of filtering of a signal in order to extract a useful component. In particular, the invention concerns a method and a device for extracting a useful component from a disturbed signal formed as the sum of a sinusoidal component and an additional component.

### BACKGROUND OF THE INVENTION

It is known to use filters which reject an unwanted part of a signal in order to only retain a useful part of the signal.

Known, for example, are low-pass filters which attenuate high frequencies, high-pass filters which attenuate low frequencies, or even band-pass filters which only allow the passage of a defined band of frequencies by attenuating the frequencies outside of the bandwidth.

A filter can be implemented with electronic components or even digitally.

When a filter is implemented with electronic components, it is referred to as an analogue filter. This type of filter is applied to continuous signals in real time. An analogue filter can be produced with passive electronic components, such as resistors, capacitors or coils. An analogue filter can also be produced with active electronic components, such as operational amplifiers, combined with passive components or transistors.

The use of an analogue filter in a device leads to increase in cost, and potentially in weight and volume of the device. Further, analogue filters are not very adaptive since they depend on the electronic components of which they are composed. In addition, analogue filters can undergo degradation over time and under certain environmental conditions, such as temperature for example.

A digital filter corresponds to a series of mathematical or algorithmic operations performed on a discrete signal. These operations are defined so that they modify the spectral content of the input signal by attenuating certain unwanted spectral components. In contrast to analogue filters, which are produced using a particular arrangement of electronic components, digital filters are produced by specific software in a computer or even by dedicated integrated circuits or programmable processors: field-programmable gate array (FPGA), digital signal processor (DSP) microcontroller, etc.

The processing principle for a digital filter is convolution: samples of the input signal are stored in a buffer memory, and samples are produced at the output. Each output sample is the sum of products of samples input to the buffer memory with coefficients held in another buffer memory. Depending on its complexity, a digital filter can therefore be relatively greedy in memory and calculation time. In addition to the cost, the use of a digital filter inevitably introduces a greater or lesser delay compared to the real signal.

In order to determine the value of a measurement bias disturbing a sinusoidal component, it is also known to calculate an average value over a period of said sinusoidal component. Such a solution does not however allow said measurement bias to be determined in real time, since it is necessary to perform an average over a complete period of the sinusoidal component before being able to determine the value of the bias. In addition, such a solution lacks precision if the value of the bias changes during the period over which the average is performed.

### OBJECT AND SUMMARY OF THE INVENTION

The object of the present invention is to remedy all or part of the disadvantages of the prior art, in particular those set out above.

To this effect, and according to a first aspect, the present invention proposes a method for processing a disturbed signal P₁ transmitting data on a communication bus of an electronic circuit, said method being implemented by a processing device, said method enabling a useful signal to be extracted from said disturbed signal P₁, said disturbed signal P₁ being measured by a sensor of the processing device. The disturbed signal P₁ is formed as the sum of a sinusoidal component S₁ and an additional component X₁. The useful signal corresponds to the additional component X₁. The values taken by the additional component X₁ are representative of the data transmitted on the communication bus. The method comprises the following steps:
determining values of the disturbed signal P₁ at three successive times t₁, t₂ and t₃,
determining values at said three times t₁, t₂ and t₃ of a signal P₂ including a sinusoidal component S₂ of the same amplitude as the sinusoidal component S₁ and in phase quadrature with respect to the sinusoidal component S₁,
calculating a value of the useful signal at time t₃ as a function of the values of the disturbed signal P₁ and the values of the signal P₂ at the three times t₁, t₂ and t₃.

By proceeding in this recurrent manner over a sliding window for the times t₁, t₂ and t₃, it is possible to reconstruct the useful signal.

The term “signal” shall mean a physical variable, for example an electrical variable (an electric potential difference, an electric current intensity, a modulation of a periodic variation of a potential or of an electric current, etc.), the variation of which over time is representative of a piece of information. The term “component” of a signal shall mean a member of a sum of signals making up said signal.

It is said that the signal P₁ is “disturbed” because it includes, in addition to a useful component directly representative of the sought information, another unwanted component which has been added to the useful component.

The term “sinusoidal component S₁” shall mean a pure sinusoidal signal which can be written in the form:

S₁=S×sin(ωt+φ) [Math. 1]

S is the “amplitude” of the sinusoidal of component S₁. This is a constant corresponding to the maximum value that can be taken by the sinusoidal component S₁. w is the angular frequency and j is the phase at the origin for the sinusoidal component S₁.

A sinusoidal component S₂ is in phase quadrature with respect to the sinusoidal component S₁ if it is phase-shifted by 90° with respect to the sinusoidal component S₁, in other words if it can be written in one the following forms:

$$\begin{matrix}{S}_{2} = S \times sin ( ω t + φ - \frac{π}{2} ) = S \times cos ( ω t + φ ) & [ Math . 2 ] \\ {S}_{2} = S \times sin ( ω t + φ + \frac{π}{2} ) = S \times ( - 1 ) \times cos ( ω t + φ ) . & [ Math . 3 ]\end{matrix}$$

Such a signal processing method according to the invention can provide a value of the useful signal at a given time almost in real time, without using an analogue or digital filter.

In particular embodiments, the invention can further include one or more of the following features, taken alone or according to all the technically possible combinations.

In particular embodiments, a value taken by the additional component X₁ at time t₃ is calculated as a function of the values of the disturbed signal P₁ and the values of the signal P₂ at the three times t₁, t₂ and t₃ in the form:

$${X}_{1} ( {t}_{3} ) = \frac{1}{2} \times \frac{{P}_{2} ( {t}_{3} ) - {P}_{2} ( {t}_{1} ) + \frac{{P}_{1}^{2} ( t 1 ) - {P}_{1}^{2} ( {t}_{2} )}{{P}_{2} ( {t}_{2} ) - {P}_{2} ( {t}_{1} )} - \frac{{P}_{1}^{2} ( {t}_{2} ) - {P}_{1}^{2} ( {t}_{3} )}{{P}_{2} ( {t}_{3} ) - {P}_{2} ( {t}_{2} )}}{\frac{{P}_{1} ( {t}_{1} ) - {P}_{1} ( {t}_{2} )}{{P}_{2} ( {t}_{2} ) - {P}_{2} ( {t}_{1} )} - \frac{{P}_{1} ( {t}_{2} ) - {P}_{1} ( {t}_{3} )}{{P}_{2} ( {t}_{3} ) - {P}_{2} ( {t}_{2} )}} . \qquad [ Math . 4 ]$$

Throughout the description, the notation Pᵢ(tⱼ) corresponds to the value of a signal Pᵢ taken at time tⱼ.

In particular embodiments, the component S₁ is a sinusoidal signal of period T, and the signal P₂ is obtained by a time shift of the disturbed signal P₁, the time shift being equal to T/4.

According to a second aspect, the present invention concerns a device for processing a disturbed signal P₁ transmitting data on a communication bus of an electronic circuit, in order to extract a useful signal from said disturbed signal P₁. The signal processing device comprises a first sensor for measuring said disturbed signal P₁. The disturbed signal P₁ is formed as the sum of a sinusoidal component S₁ and an additional component X₁. The useful signal corresponds to the additional component X₁. The values taken by the additional component X₁ are representative of the data transmitted on the communication bus. The device further comprises a processing unit configured for:
determining, based on measurements carried out by said first sensor, values of the disturbed signal P₁ at three successive times t₁, t₂ and t₃,
determining values, at said three times t₁, t₂ and t₃, of a signal P₂ comprising a sinusoidal component S₂ of the same amplitude as the sinusoidal component S₁ and in phase quadrature with respect to the sinusoidal component S₁, and
calculating a value of the useful signal at time t₃ as a function of the values of the disturbed signal P₁ and the values of the signal P₂ at the three times t₁, t₂ and t₃.

In particular embodiments, the invention can further include one or more of the following features, taken alone or according to all the technically possible combinations.

In particular embodiments, a value of the additional component X₁ at time t₃ is calculated as a function of the values of the disturbed signal P₁ and the values of the signal P₂ at the three times t₁, t₂ and t₃ in the form:

$${X}_{1} ( {t}_{3} ) = \frac{1}{2} \times \frac{{P}_{2} ( {t}_{3} ) - {P}_{2} ( {t}_{1} ) + \frac{{P}_{1}^{2} ( t 1 ) - {P}_{1}^{2} ( {t}_{2} )}{{P}_{2} ( {t}_{2} ) - {P}_{2} ( {t}_{1} )} - \frac{{P}_{1}^{2} ( {t}_{2} ) - {P}_{1}^{2} ( {t}_{3} )}{{P}_{2} ( {t}_{3} ) - {P}_{2} ( {t}_{2} )}}{\frac{{P}_{1} ( {t}_{1} ) - {P}_{1} ( {t}_{2} )}{{P}_{2} ( {t}_{2} ) - {P}_{2} ( {t}_{1} )} - \frac{{P}_{1} ( {t}_{2} ) - {P}_{1} ( {t}_{3} )}{{P}_{2} ( {t}_{3} ) - {P}_{2} ( {t}_{2} )}} . \qquad [ Math . 4 ]$$

In particular embodiments, the component S₁ is a sinusoidal signal of period T and the processing unit is configured to determine a value of the signal P₂ at a time tᵢ based on the value of the disturbed signal P₁ at time tᵢ−T/4 or at time tᵢ+T/4.

According to a third aspect, the present invention concerns an electronic circuit including a communication bus intended for supporting the transmission of a disturbed data signal P₁, and a processing device according to one of the preceding embodiments for extracting a useful signal from said disturbed signal P₁.

According to a fourth aspect, the present invention concerns a resolver including a signal processing device according to any one of the preceding embodiments. The resolver includes a stator and a rotor. The rotor includes a primary coil. The stator includes a first secondary coil and a second secondary coil. The first secondary coil and the second secondary coil are arranged at 90° with respect to one another.

The signal P₁ is determined based on a voltage induced by the primary coil in the first secondary coil, measured by the first sensor. The signal P₂ is determined based on a voltage induced by the primary coil in the second secondary coil, measured by the second sensor.

The signals P₁ and P₂ each respectively include a sinusoidal component S₁ and S₂ in phase quadrature and of same amplitude. The signal P₁ includes an additional component X₁. The signal P₂ includes an additional component X₂.

The values of the component S₁ and S₂ at time t₃ are calculated as a function of the values of the disturbed signals P₁ and P₂ at three times t₁, t₂ and t₃. An angle of rotation of the rotor at time t₃ is then determined as a function of the values of the sinusoidal components S₁ and S₂ at time t₃.

### BRIEF DESCRIPTION OF THE DRAWINGS

The invention will be better understood on reading the following description, given by way of a non-limiting example, and with reference to FIGS. 1 to 9, in which:

FIG. 1 schematically shows a signal processing device according to the invention;

FIG. 2 schematically shows the main steps of a method according to the invention for extracting a useful signal from a disturbed signal;

FIG. 3 schematically shows a sinusoidal component S₁, of a useful signal X₁, and of a signal P₁ formed as the sum of the two component S₁ and X₁;

FIG. 4 schematically shows the determination of the values of a signal P₁ and of a signal P₂ at three times t₁, t₂ and t₃, the signal P₂ corresponding to a time shift of the signal P₁;

FIG. 5 schematically shows a signal P₁ and a signal P₂ each respectively including sinusoidal components S₁ and S₂ in phase quadrature and of same amplitude with respect to one another;

FIG. 6 schematically shows a resolver including a processing device according to the invention;

FIG. 7 schematically shows the determination of the values of signals P₁ and P₂ shown in FIG. 5 at three times t₁, t₂ and t₃;

FIG. 8 schematically shows the values taken by the signals P₁ and P₂ over time; and

FIG. 9 schematically shows the values taken by the signals P₁ and P₂ at three times t₁, t₂ and t₃.

In these Figures, identical references of one Figure with another designate the same or similar elements. For reasons of clarity, the elements shown are not necessarily on the same scale, unless otherwise indicated.

### DETAILED DESCRIPTION OF AN EMBODIMENT OF THE INVENTION

As previously indicated, the present invention aims to provide a solution that is compact, inexpensive and almost real-time, for extracting a useful signal from a disturbed signal.

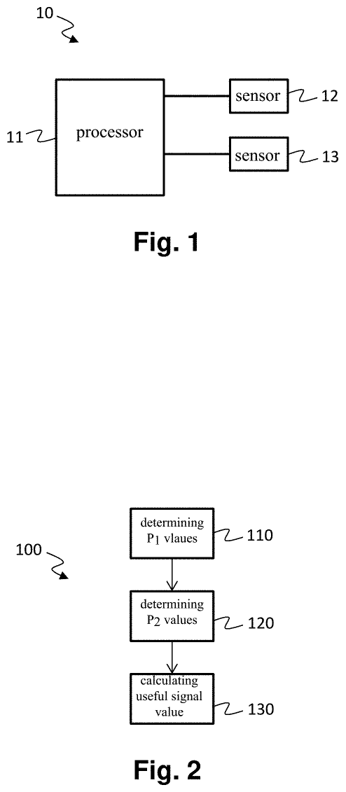

FIG. 1 schematically shows a signal processing device 10 including a first sensor 12 for measuring a disturbed signal P₁. The signal P₁ represents a physical variable, for example an electrical variable (an electric potential difference, an electric current intensity, a modulation of a periodic variation of a potential or of an electric current, etc.), the variation of which over time is representative of a piece of information. It is said that the signal P₁ is “disturbed” because it includes, in addition to a useful component directly representative of the sought information, an unwanted component which has been added to the useful component. In the context of the invention, it is considered that the disturbed signal P₁ is formed as the sum of a sinusoidal component S₁ and an additional component X₁. The useful signal corresponds either to the sinusoidal component S₁ or to the additional component X₁.

In certain embodiments, the signal processing device 10 can include a second sensor 13.

The signal processing device 10 further includes a processing unit 11. The processing unit 11 is capable of collecting measurements performed by the sensors 12, 13. For this purpose, the sensors 12, 13 and the processing unit 11 can communicate, for example, via a wired communication or via a wireless communication. The processing unit 11 includes, for example, one or more processors and a memory (magnetic hard disk, electronic memory, optical disc, etc.) in which a computer program product is stored in the form of a set of program code instructions to be executed in order to implement the various steps of a signal processing method for extracting a useful signal from a disturbed signal. Alternatively or in addition, the processing unit 11 includes one or more programmable logic circuits (FPGA, PLO, etc.), and/or one or more specialised integrated circuits (ASIC), and/or an assembly of discrete electronic components etc., capable of implementing all or some of said steps of said method.

FIG. 2 schematically shows the main steps of such a signal processing method 100 for extracting a useful signal from a disturbed signal P₁ including a sinusoidal component S₁. The method 100 comprises the following steps:
determining 110, based on measurements carried out by the first sensor 12, values of the disturbed signal P₁ at three successive times t₁, t₂ and t₃,
determining 120 values, at said three times t₁, t₂ and t₃, of a signal P₂ including a sinusoidal component S₂ of the same amplitude as the sinusoidal component S₁ and in phase quadrature with respect to the sinusoidal component S₁,
calculating 130 a value of the useful signal at time t₃ as a function of the values of the disturbed signal P₁ and the values of the signal P₂ at the three times t₁, t₂ and t₃.

Various methods can be envisaged for determining the values at said three times t₁, t₂ and t₃ of a signal P₂ including a sinusoidal component S₂ of the same amplitude as the sinusoidal component S₁ and in phase quadrature with respect to the sinusoidal component S₁.

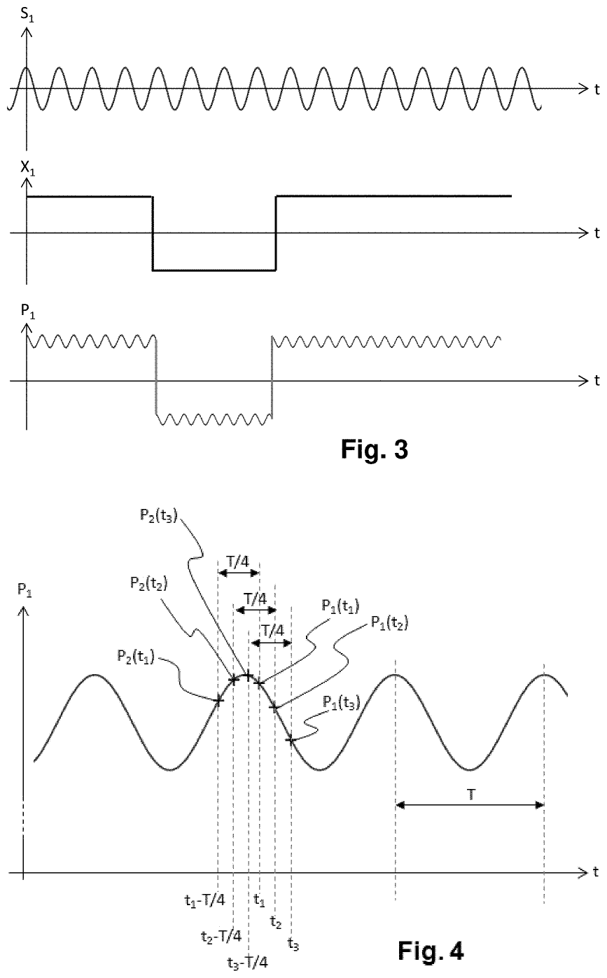

FIG. 3 schematically shows a sinusoidal component S₁, an additional component X₁ and the signal P₁, for a first embodiment of the signal processing method 100 according to the invention. The signal P₁ is formed as the sum of the two components S₁ and X₁. The components S₁ and X₁ and the signal P₁ are shown as a function of time: time is shown as abscissa, while a value taken over time by the signal P₁ or by the components S₁ and X₁ is shown as ordinate.

For this first embodiment, the useful signal corresponds to the additional component X₁. It is, for example, a signal having continuous portions that are substantially constant, the values of which are representative of data transmitted on a communication bus of an electronic circuit. For example, the value of a substantially constant continuous portion corresponds to a value taken by one or more data bits, or by one or more symbols participating in the coding of a data bit. The sinusoidal component S₁ corresponds to a disturbance signal which is added to the useful signal. It may, for example, be a sinusoidal signal of frequency 50 Hz originating from the electromagnetic coupling between the electronic circuit forming the communication bus and conductors of the electricity supply grid. The signal P₁ corresponds to the sum of the additional component X₁, in other words the useful signal, with the sinusoidal component S₁, in other words the disturbance signal.

In order to limit the calculation error of the useful signal X₁ at time t₃, the times t₁, t₂ and t₃ can advantageously be chosen so that a variation of X₁ in the interval [t₁; t₃] is low, for example less than 1.4%, or even less than 1%, compared to the amplitude of the sinusoidal component S₁.

The curve shown in FIG. 4 is an enlarged view of a portion of the signal P₁ shown in FIG. 3. Over this portion, the additional component X₁ maintains a constant or almost constant value. FIG. 4 illustrates how it is possible to determine the values, at the three times t₁, t₂ and t₃, of a signal P₂ comprising a sinusoidal component S₂ of the same amplitude as the sinusoidal component S₁ and in phase quadrature with respect to the sinusoidal component S₁.

Indeed it is possible to artificially create a signal P₂ corresponding to an image of the signal P₁ shifted in time by a quarter period of the sinusoidal component S₁. Such a signal P₂ has, by construction, a sinusoidal component S₂ of the same amplitude as the sinusoidal component S₁ and in phase quadrature with respect to the sinusoidal component S₁, In the example shown in FIG. 4, the signal P₂ is leading in phase with respect to the signal P₁.

If T denotes the period of the sinusoidal component S₁, it then appears that the value taken by the signal P₂ at a time t₁ corresponds to the value taken by the signal P₁ at a time (t₁−T/4), the value taken by the signal P₂ at a time t₂ correspond to the value taken by the signal P₁ at a time (t₂−T/4), and the value taken by the signal P₂ at a time t₃ corresponds to the value taken by the signal P₁ at a time (t₃−T/4):

P₂(t₁)=P₁(t₁−T/4),

P₂(t₂)=P₁(t₂−T/4),

P₂(t₃)=P₁(t₃−T/4).

In the example considered, the processing unit 11 is paced by a clock, the frequency of which is at least four times higher than the frequency of the sinusoidal component S₁. The processing unit 11 is configured to sample the signal P₁ at times (t₁−T/4), (t₂−T/4), (t₃−T/4), t₁, t₂ and t₃. Thus, values are obtained of the signal P₁ and of the signal P₂ at the times t₁, t₂ and t₃. These values are stored in the memory of the processing unit 11.

It should be noted that it may be sufficient to sample the signal P₁ at only four times, if the times t₁, t₂ and t₃ are chosen so that t₂=(t₃−T/4) and t₁=(t₂−T/4). The times t₁, t₂, t₃ do not however necessarily correspond to regular intervals.

It should also be noted that it is possible, in an alternative, to artificially create a signal P₂ lagging in phase by a quarter period with respect to the signal P₁. In this case:

P₂(t₁)=P₁(t₁+T/4),

P₂(t₂)=P₁(t₂+T/4),

P₂(t₃)=P₁(t₃+T/4).

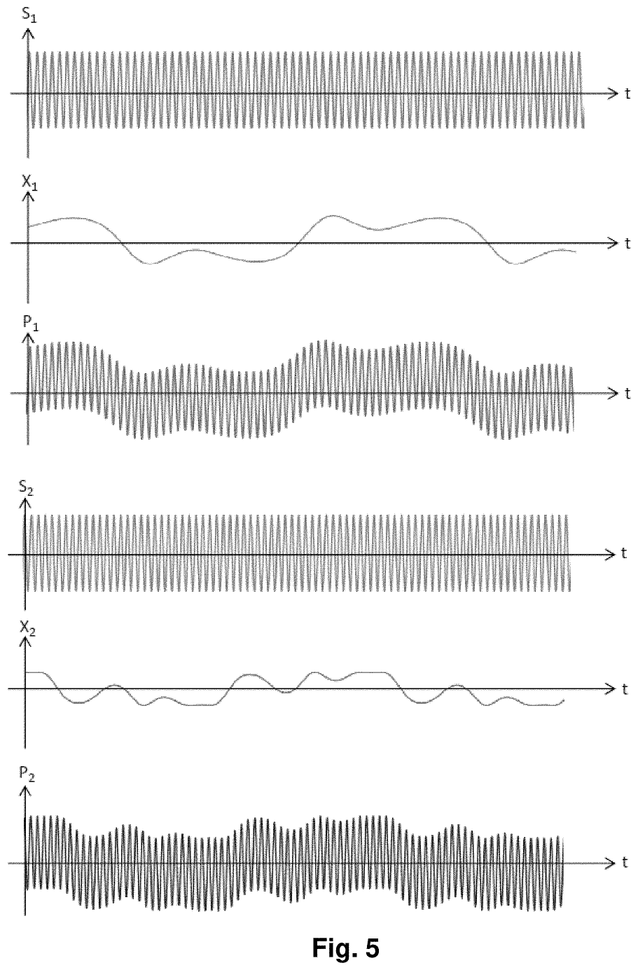

FIG. 5 schematically shows a signal P₁ and a signal P₂ for another particular embodiment of the signal processing method 100 according to the invention.

The signal P₁ and the signal P₂ each respectively include a sinusoidal component S₁ and a sinusoidal component S₂. The sinusoidal components S₁ and S₂ are in phase quadrature with respect to one another and of same amplitude. The signal P₁ is formed as the sum of the sinusoidal component S₁ and an additional component X₁. With regard to the signal P₁, this is formed as the sum of the sinusoidal component S₂ and an additional component X₂.

For each graph illustrated in FIG. 5, the time is shown as abscissa, while a value taken over time by the signals P₁ and P₂ by the components S₁, S₂, X₁ and X₂ is shown as ordinate.

In the particular embodiment described with reference to FIG. 5, for the signal P₁, the useful signal corresponds to the sinusoidal component S₁, while the additional component X₁ corresponds to a disturbance signal. Similarly, for the signal P₂, the useful signal corresponds to the sinusoidal component S₂, while the additional component X₂ corresponds to a disturbance signal. The additional components X₁ and X₂ are, for example, random signals corresponding to a disturbance of technical or environmental origin (poor design of the electronic measurement circuit, bias introduced in the measurement of the sensor, influence of temperature or humidity on the measured value of the signal, interference from parasite signals originating from other electronic devices, etc.).

A signal processing device 10 implementing the particular embodiment described with reference to FIG. 5 includes a second sensor 13 allowing the signal P₂ to be the measured.

In the example considered and illustrated in FIG. 5, it is because of the nature of the signals P₁ and P₂ and because of the manner in which the sensors are arranged, that the sinusoidal components S₁ and S₂ are in phase quadrature and have the same amplitude.

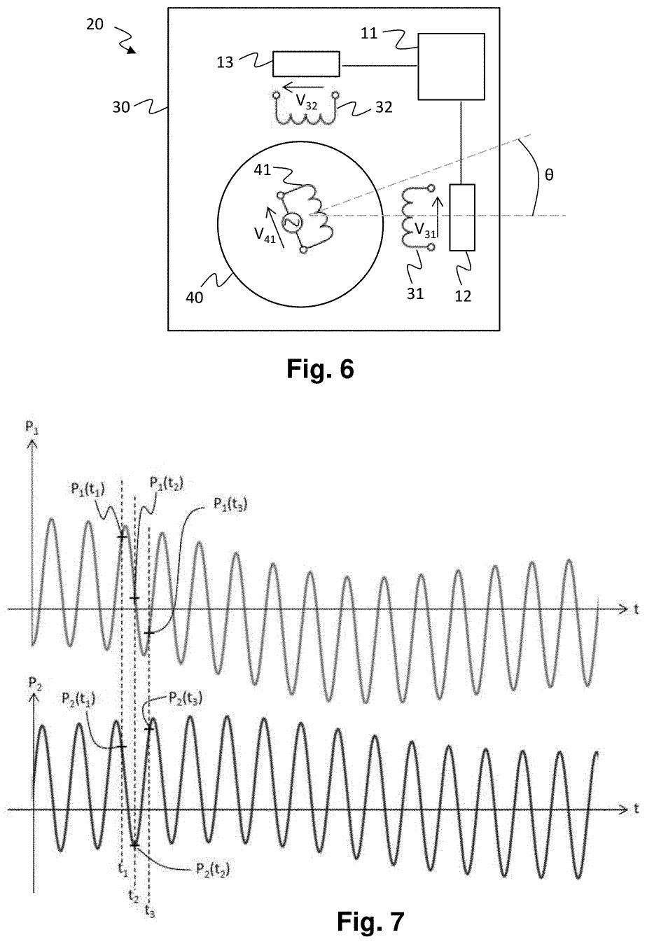

Such a signal processing device 10 can, in particular, be implemented in a resolver 20 such as that illustrated in FIG. 6. The resolver 20 includes a stator 30 and a rotor 40. The rotor 40 includes a primary coil 41. The stator includes a first secondary coil 31 and a second secondary coil 32. The first secondary coil 31 and the second secondary coil 32 are arranged at 90° with respect to one another. The primary coil 41 is supplied with a sinusoidal voltage V₄₁ of amplitude V₀ and angular frequency w:

V₄₁=V₀×sin(ωt) [Math. 7]

A voltage induced by the primary coil 41 in each secondary coil 31, 32 then varies sinusoidally during the rotation of the rotor:

V₃₁=K×cos θ×V₀×sin(ωt+φ) [Math. 8]

V₃₂=K×sin θ×V₀ sin(ωt+φ) [Math. 9]

where:

K is a constant representative of a transformer ratio of the resolver 20,

q is an angle of rotation of the rotor 40 with respect to the stator 30,

j is a phase shift between the voltage V₄₁ at the terminals of the primary coil 41 and the voltages V₃₁ and V₃₂ at the terminals of the first secondary coil 31 and the second secondary coil 32 respectively.

The signal processing device 10 includes a first sensor 12 for measuring a signal P₁ obtained after demodulation of the voltage V₃₁ observed at the terminals of the first secondary coil 31. The signal can further include an additional component X₁ corresponding to a disturbance signal:

P₁=K×V₀×cos θ+X₁ [Math. 10]

Similarly, the signal processing device 10 includes a second sensor 13 for measuring a signal P₂ obtained after demodulation of the voltage V₃₂ observed at the terminals of the second secondary coil 32. This signal can also include an additional component X₂ corresponding to a disturbance signal:

P₂=K×V₀×sin θ+X₂ [Math. 11]

This is then a similar case to that shown in FIG. 5 with:

S₁=K×V₀×cos θ [Math. 12]

S₂=K×V₀×sin θ [Math. 13]

The curves shown in FIG. 7 are enlarged views of a portion of the signal P₁ and a portion of the signal P₂ respectively, shown in FIG. 5. As illustrated in FIG. 7, it is possible to determine the values, at three times t₁, t₂ and t₃, of the signal P₁ and of the signal P₂, the signal P₂ including a sinusoidal component S₂ of same amplitude and in phase quadrature with respect to the sinusoidal component S₁ of the signal P₁.

For this purpose, the processing unit 11 is paced by a clock and configured to sample the signal P₁ and the signal P₂ based on the values obtained respectively by the first sensor 12 and by the second sensor 13 at times t₁, t₂, t₃. The values taken by the signals P₁ and P₂ at the times t₁, t₂, t₃ are stored in the memory of the processing unit 11 of the signal processing device 10.

It should be noted that the times t₁, t₂, t₃ do not however necessarily correspond to regular intervals.

The remainder of the description attempts to detail how the value of the useful signal at a time t₃ can be calculated based on the values of the disturbed signal P₁ and the values of the signal P₂ measured at three times t₁, t₂ and t₃.

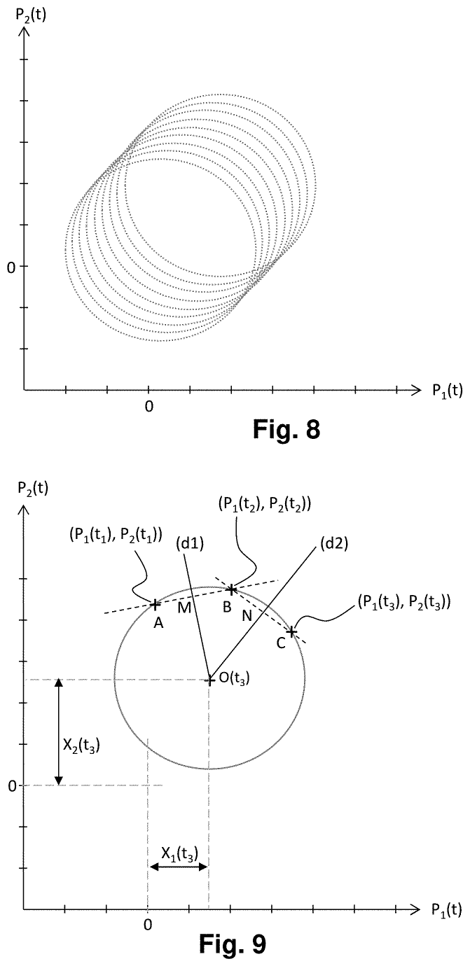

FIG. 8 schematically shows the change in the values of a signal P₁ and a signal P₂ over time, when the signals P₁ and P₂ respectively include a sinusoidal component S₁ and a sinusoidal component S₂ of same amplitude and in phase quadrature with respect to one another. The signals P₁ and P₂ further include an additional component X₁ and an additional component X₂ respectively. The values taken by the signal P₁ over time are shown as abscissa; the values taken by the signal P₂ over time are shown as ordinate. The sinusoidal component S₁ and S₂ therefore draw out a circle over time, the centre of which moves due to the additional components X₁ and X₂.

At a given time t₀, considering that the additional components X₁ and X₂ vary relatively little around the time t₀, the centre of a circle drawn by the values taken by the sinusoidal components S₁ and S₂ at times close to t₀ have as abscissa the value taken by the signal X₁ at time t₀, and for ordinate have the value taken by the signal X₂ at time t₀.

Hence, and as illustrated in FIG. 9, for the sampling times t₁, t₂ and t₃, the point A having coordinates (P₁(t₁), P₂(t₁)), the point B having coordinates (P₁(t₂), P₂(t₂)), and the point C having coordinates (P₁(t₃), P₂(t₃)) are substantially located on a circle, the radius of which is equal to the amplitude of the sinusoidal components S₁ and S₂ and the centre of which is a point O having coordinates (X₁(t₃), X₂(t₃)).

It is useful to note that this remains valid as long as the components X₁ and X₂ are such, and the times t₁, t₂, and t₃ are chosen so that a variation of the signal X₁ and a variation of the signal X₂ within the interval [t₁; t₃] remains relatively low compared to the amplitude of the sinusoidal components S₁ and S₂.

Preferably, in order to guarantee a good precision of the measurements, a variation of the signal X₁ and a variation of the signal X₂ within the interval [t₁; t₃] are each respectively less than 1.4% of the amplitude of the sinusoidal components S₁ and S₂.

In other words, if S denotes the value of the amplitude of the sinusoidal components S₁ and S₂, then preferably:

∀tᵢ, tⱼ ∈ [t₁;t₃], |X₁(tᵢ)−X₁(tⱼ)|<1.4%×S [Math. 14]

∀tᵢ, tⱼ ∈ [t₁;t₃], |X₂(tᵢ)−X₂(tⱼ)|<1.4%×S [Math. 15]

Still more preferably, a variation of the signal X₁ and a variation of the signal X₂ within the interval [t₁; t₃] is less than 1% of the amplitude of the sinusoidal components S₁ and S₂.

As illustrated in FIG. 9, the segments [AB] and [BC] form chords of a circle, the radius of which is equal to the amplitude of the sinusoidal components S₁ and S₂, and their respective bisectors (d1) and (d2) intersect at the centre 0 of this circle. By naming M the midpoint of the segment [AB] and N the midpoint of the segment [BC], the following scaler products are zero:

\vec{AB}·\vec{OM}=0 [Math. 16]

\vec{BC}·\vec{ON}=0 [Math. 17]

which translates as:

$$\begin{matrix}( {P}_{1} ( {t}_{2} ) - {P}_{1} ( {t}_{1} ) ) \times ( {X}_{1} ( {t}_{3} ) - \frac{{P}_{1} ( {t}_{2} ) - {P}_{1} ( {t}_{1} )}{2} ) + ( {P}_{2} ( {t}_{2} ) - {P}_{2} ( {t}_{1} ) ) \times ( {X}_{2} ( {t}_{3} ) - \frac{{P}_{2} ( {t}_{2} ) - {P}_{2} ( {t}_{1} )}{2} ) = 0 & [ Math . 18 ] \\ ( {P}_{1} ( {t}_{3} ) - {P}_{1} ( {t}_{2} ) ) \times ( {X}_{1} ( {t}_{3} ) - \frac{{P}_{1} ( {t}_{3} ) - {P}_{1} ( {t}_{2} )}{2} ) + ( {P}_{2} ( {t}_{3} ) - {P}_{2} ( {t}_{2} ) ) \times ( {X}_{2} ( {t}_{3} ) - \frac{{P}_{2} ( {t}_{3} ) - {P}_{2} ( {t}_{2} )}{2} ) = 0. & [ Math . 19 ]\end{matrix}$$

These two equations then make it possible to obtain:

$$\begin{matrix}{X}_{1} ( {t}_{3} ) = \frac{1}{2} \times \frac{{P}_{2} ( {t}_{3} ) - {P}_{2} ( {t}_{1} ) + \frac{{P}_{1}^{2} ( t 1 ) - {P}_{1}^{2} ( {t}_{2} )}{{P}_{2} ( {t}_{2} ) - {P}_{2} ( {t}_{1} )} - \frac{{P}_{1}^{2} ( {t}_{2} ) - {P}_{1}^{2} ( {t}_{3} )}{{P}_{2} ( {t}_{3} ) - {P}_{2} ( {t}_{2} )}}{\frac{{P}_{1} ( {t}_{1} ) - {P}_{1} ( {t}_{2} )}{{P}_{2} ( {t}_{2} ) - {P}_{2} ( {t}_{1} )} - \frac{{P}_{1} ( {t}_{2} ) - {P}_{1} ( {t}_{3} )}{{P}_{2} ( {t}_{3} ) - {P}_{2} ( {t}_{2} )}} & [ Math . 4 ] \\ {X}_{2} ( {t}_{3} ) = [ {X}_{1} ( {t}_{3} ) - \frac{1}{2} \times ( {P}_{1} ( {t}_{2} ) + {P}_{1} ( {t}_{3} ) ) ] \times \frac{{P}_{1} ( {t}_{2} ) - {P}_{1} ( {t}_{3} )}{{P}_{2} ( {t}_{3} ) - {P}_{2} ( {t}_{2} )} + \frac{1}{2} \times ( {P}_{2} ( {t}_{2} ) + {P}_{2} ( {t}_{3} ) ) . & [ Math . 6 ]\end{matrix}$$

It is thus possible to calculate a value of the useful signal at time t₃ as a function of the values of the signal P₁ and the values of the signal P₂ at three times t₁, t₂ and t₃. Indeed, if the useful signal corresponds to the additional component X₁, then the value of the useful signal is the value X₁(t₃) calculated above; if the useful signal corresponds to the sinusoidal component S₁, then the value of the useful signal at time t₃ is equal to:

S₁(t₃)=P₁(t₃)−X₁(t₃) [Math. 5]

It is thus possible to obtain a large number of values of the useful signal as a function of time, by proceeding in a recurrent manner by choosing a large number of triplets (t₁, t₂ and t₃). Advantageously, the times t₁, t₂ and t₃ can be determined over a sliding window. It is thus possible to reconstruct the useful signal extracted from the disturbed signal.

In the first embodiment described with reference to FIGS. 3 and 4, the values taken by the additional component X₁ are representative of data transmitted on a data bus. The additional component X₁ corresponds to the useful signal, while the sinusoidal component S₁ corresponds to a disturbance signal which is added to the useful signal. Measurements of the signal P₁ can be carried out recurrently, and as soon as six measurements (or optionally four measurements) of the signal P₁ at times (t₁−T/4), (t₂−T/4), (t₃−T/4), t₁, t₂, t₃ are available (T being the period of the sinusoidal component S₁), then the signal processing method 100 makes it possible to calculate a value X₁(t₃) of the useful signal at time t₃. The value X₁(t₃) corresponds to a value at time t₃ of the signal supplied by the data bus, for which the unwanted sinusoidal disturbance has been removed.

It should be noted that in this first embodiment, it is preferable that the measurements of the signal P₁ necessary for the calculation 130 of a value of the useful signal are carried out over a period of time during which the component X₁ retains a substantially constant value (in other words, carrying out these measurements over a period of time which overlaps two portions during which the additional component X₁ takes different constant values, should be avoided). For this purpose, it is possible, for example, to check that the different measurements of the signal P₁ used for the calculation 130 of the value of the useful signal do not vary from one to the other by a value greater than a certain threshold.

In the second embodiment described with reference to FIGS. 5 to 7, the additional components X₁ and X₂ correspond to a disturbance of the signals P₁ and P₂ measured, respectively, by the first sensor 12 and the second sensor 13. The sinusoidal components S₁ and S₂ by contrast correspond to the useful signals which should be extracted from the signal P₁ and from the signal P₂ respectively.

Measurements of the signals P₁ and P₂ can be carried out recurrently by the first sensor 12 and by the second sensor 13 of the signal processing device 10. As soon as three measurements for each signal are available at times t₁, t₂ and t₃, the signal processing method 100 can calculate a value X₁(t₃) of the component X₁ at time t₃ and a value X₂(t₃) of the component X₂ at time t₃ in order to deduce the values S₁(t₃) and S₂(t₃) of the useful signals S₁ and S₂ at time t₃. It is then possible to define the value of the angle of rotation q of the rotor 40 with respect to the stator 30 of the resolver 20 at time t₃:

$$θ ( {t}_{3} ) = arctan ( \frac{{S}_{2} ( {t}_{3} )}{{S}_{1} ( {t}_{3} )} ) . \qquad [ Math . 20 ]$$

The above description clearly illustrates that, through these different features and their advantages, the present invention achieves the objectives set.

The signal processing method 100 according to the invention and its associated device 10 enable a useful signal to be extracted from a disturbed signal when said disturbed signal comprises a sinusoidal component.

This method 100 can be easily implemented by a processing unit 11 responsible for collecting and processing measurements of a disturbed signal supplied by a sensor 12, 13.

The method 100 does not require the use of a hardware filter based on electronic components which can be, depending on the targeted application, heavy, bulky and expensive.

The method 100 also does not require the use of a digital filter often requiring significant calculation and memory resources.

The method 100 is based on a calculation 130 which gives an immediate value of the useful signal to be extracted at a given time based on at most six measurements. The determination of a value of the useful signal at a given time is therefore carried out with a strong reactivity, almost instantaneously, which is a considerable advantage for so-called “real-time” systems.

In general, it should be noted that the embodiments considered above have been described by way of non-limiting examples, and that other variants can consequently be envisaged.

In particular, the invention has been described for an embodiment relating to a signal supplied by a data bus, and for an embodiment relating to two signals supplied by a resolver. The invention is nevertheless applicable to other embodiments.

Indeed, the method is applicable whenever it is possible to express a physical phenomenon by a sinusoidal signal which could contain a measurement error, or even by any signal which could be disturbed by a sinusoidal signal. In order to obtain good precision of the calculation 130 of a value of the useful signal to be extracted, it is nevertheless preferable to use sampling intervals such that the additional component X₁, X₂ varies little with respect to the amplitude of the sinusoidal component S₁, S₂ during the period of time over which the measurements necessary for said calculation 130 are performed.

1-7. (canceled)

8. A method for processing a disturbed signal P₁ transmitting data on a communication bus of an electronic circuit, the method being implemented by a processing device, the method enabling a useful signal to be extracted from the disturbed signal P₁, the disturbed signal P₁ being measured by a first sensor of the processing device, the disturbed signal P₁ being formed as a sum of a sinusoidal component S₁ and an additional component X₁, the useful signal corresponding to the additional component X₁, values of the useful signal being representative of the data transmitted on the communication bus, the method comprising:
determining values of the disturbed signal P₁ at three successive times t₁, t₂ and t₃;
determining values, at the three successive times t₁, t₂ and t₃, of a signal P₂ comprising a sinusoidal component S₂ of a same amplitude as the sinusoidal component S₁ and in phase quadrature with respect to the sinusoidal component S₁; and
calculating a value of the useful signal at time t₃ as a function of the values of the disturbed signal P₁ and the values of the signal P₂ at the three successive times t₁, t₂ and t₃.

9. The method of claim 8, wherein a value of the additional component X₁ at time t₃ is calculated as a function of the values of the disturbed signal P₁ and the values of the signal P₂ at the three successive times, t₁, t₂ and t₃ as follows:
$${X}_{1} ( {t}_{3} ) = \frac{1}{2} \times \frac{{P}_{2} ( {t}_{3} ) - {P}_{2} ( {t}_{1} ) + \frac{{P}_{1}^{2} ( t 1 ) - {P}_{1}^{2} ( {t}_{2} )}{{P}_{2} ( {t}_{2} ) - {P}_{2} ( {t}_{1} )} - \frac{{P}_{1}^{2} ( {t}_{2} ) - {P}_{1}^{2} ( {t}_{3} )}{{P}_{2} ( {t}_{3} ) - {P}_{2} ( {t}_{2} )}}{\frac{{P}_{1} ( {t}_{1} ) - {P}_{1} ( {t}_{2} )}{{P}_{2} ( {t}_{2} ) - {P}_{2} ( {t}_{1} )} - \frac{{P}_{1} ( {t}_{2} ) - {P}_{1} ( {t}_{3} )}{{P}_{2} ( {t}_{3} ) - {P}_{2} ( {t}_{2} )}} .$$

10. The method of claim 8, wherein the component S₁ is a sinusoidal signal of period T and the signal P₂ is obtained by a time shift of the disturbed signal P₁, the time shift being equal to T/4.

11. A processing device to process a disturbed signal P₁, transmitting data on a communication bus of an electronic circuit, to extract a useful signal from the disturbed signal P₁, the device comprising:
a first sensor to measure the disturbed signal P₁, the disturbed signal P₁ being formed as a sum of a sinusoidal component S₁ and an additional component X₁, the useful signal corresponding to the additional component X₁, values of the useful signal are representative of the data transmitted on communication bus;
a processor configured to:
determine, based on measurements performed by the first sensor, values of the disturbed signal P₁ at three successive times t₁, t₂ and t₃;
determine values, at the three successive times t₁, t₂ and t₃, of a signal P₂ comprising a sinusoidal component S₂ of a same amplitude as the sinusoidal component S₁ and in phase quadrature with respect to the sinusoidal component S₁; and
calculate a value of the useful signal at time t₃ as a function of the values of the disturbed signal P₁ and the values of the signal P₂ at the three successive times t₁, t₂ and t₃.

12. The processing device of claim 11, wherein a value of the additional component X₁ at time t₃ is calculated as a function of the values of the disturbed signal P₁ and the values of the signal P₂ at the three times t₁, t₂ and t₃ as follows:
$${X}_{1} ( {t}_{3} ) = \frac{1}{2} \times \frac{{P}_{2} ( {t}_{3} ) - {P}_{2} ( {t}_{1} ) + \frac{{P}_{1}^{2} ( t 1 ) - {P}_{1}^{2} ( {t}_{2} )}{{P}_{2} ( {t}_{2} ) - {P}_{2} ( {t}_{1} )} - \frac{{P}_{1}^{2} ( {t}_{2} ) - {P}_{1}^{2} ( {t}_{3} )}{{P}_{2} ( {t}_{3} ) - {P}_{2} ( {t}_{2} )}}{\frac{{P}_{1} ( {t}_{1} ) - {P}_{1} ( {t}_{2} )}{{P}_{2} ( {t}_{2} ) - {P}_{2} ( {t}_{1} )} - \frac{{P}_{1} ( {t}_{2} ) - {P}_{1} ( {t}_{3} )}{{P}_{2} ( {t}_{3} ) - {P}_{2} ( {t}_{2} )}} .$$

13. The processing device of claim 11, wherein the component S₁ is a sinusoidal signal of period T; and wherein the processor is configured to determine a value of the signal P₂ at a time tᵢ based on the value of the disturbed signal P₁ at time tᵢ−T/4 or at time tᵢ+T/4.

14. An electronic circuit comprising the communication bus to support transmission of the disturbed signal P₁ and the processing device of claim 11 to extract the useful signal from the disturbed signal P₁.
